(19) United States
(12) Patent Application Publication
(10) Pub. No.: US 2024/0127517 A1
(43) Pub. Date: Apr. 18, 2024

(54) SYNTHESIZING A PRODUCT IMAGE FROM A COMPUTER AIDED DESIGN (CAD) PRODUCT MODEL

(71) Applicant: McMaster-Carr Supply Company, Elmhurst, IL (US)

(72) Inventors: Emily RAPPORT, Chicago, IL (US); Alex Cavanaugh, Chicago, IL (US); Daniel Gonzalez, Prosper, TX (US); Sachin Nair, Chicago, IL (US); Kay Anley, Chicago, IL (US); Paige Altemare, Elmhurst, IL (US); Mike Rosenholtz, Elmhurst, IL (US); Satchel Siegel, Chicago, IL (US); Blake Norwick, Chicago, IL (US); Nick Dennis, Chicago, IL (US)

(21) Appl. No.: 18/488,415

(22) Filed: Oct. 17, 2023

Related U.S. Application Data
(60) Provisional application No. 63/416,824, filed on Oct. 17, 2022.

(51) Int. Cl. G06T 11/60; G06Q 30/0241; G06Q 30/0601; G06T 15/20; G06T 19/20

(52) U.S. Cl. CPC G06T 11/60; G06Q 30/0277; G06Q 30/0603; G06T 15/20; G06T 19/20; G06T 2219/2016

(57) ABSTRACT

Systems, methods, and apparatuses disclosed herein standardize product views of product images in the product catalog such that these products are displayed with substantially similar products views with respect to one another in the product catalog to enhance the visual appearance, or photorealism, of the product catalog. As such, the products within the same category of products, for example, the screws and bolts as described above, are illustrated in the product catalog with similar product views, for example, similar orientations, similar scales, and/or similar angles, with respect to one another. From the example above, even though the product CAD models can portray the products within the category of products using the standard right-side product view or the standard front-side product view, these systems, methods, and apparatuses standardize the product views of these products in the product catalog to be substantially uniform, for example, have substantially similar product views, with respect to one another to enhance the visual appearance, or photorealism, of the product catalog.

### CROSS-REFERENCE TO RELATED APPLICATIONS

The present application claims the benefit of U.S. Provisional Patent Application No. 63/416,824, filed Oct. 17, 2022, which is incorporated herein by reference in its entirety.

### BACKGROUND

Product distributors often advertise their products, ranging from simple products such as screws and bolts to more complex products such as robotically controlled tools and workstations, for sale to customers using product catalogs. Conventionally, manufacturers of these products can generate three-dimensional computer-generated illustrations, also referred to as computer aided design (CAD) product models, for their products for display in a product catalog. And in some instances, the product distributor can generate the product CAD models itself. However, these product CAD models, whether generated by the manufacturers or the product distributor, can portray the products therein using different product views, for example, different orientations, different scales, different lighting, and/or different angles, with respect to one another. Some product CAD models for products within a category of products, for example, screws and bolts, might portray these products using a standard right-side product view while other product CAD models for other products within the same category of products might portray these products using a standard bottom-top product view. As such, these product CAD models, if placed into product catalog, could drastically differ with respect to one another even if these products are within the same category of products.

### BRIEF DESCRIPTION OF THE DRAWINGS/FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 illustrates a block diagram of an exemplary product distribution platform according to some embodiments of the present disclosure.

FIG. 2A illustrates a block diagram of an exemplary image rendering computing system that can be implemented within the exemplary product distribution platform according to some embodiments of the present disclosure.

FIG. 2B illustrates a flowchart of an exemplary operation of the exemplary image rendering computing system according to some exemplary embodiments of the present disclosure.

FIG. 3A through FIG. 3G graphically illustrate exemplary operations of the exemplary image rendering computing system according to some embodiments of the present disclosure.

FIG. 4 illustrates a flowchart of an exemplary operation of the exemplary image rendering computing system to synthesize the product image of the product utilizing the exemplary operations of the exemplary image rendering computing system according to some embodiments of the present disclosure.

FIG. 5A and FIG. 5B graphically illustrate exemplary product computer aided design (CAD) models that can be utilized within the exemplary product distribution platform according to some embodiments of the present disclosure.

FIG. 6A and FIG. 6B graphically illustrate exemplary product images that can be synthesized by the exemplary product distribution platform according to some embodiments of the present disclosure.

FIG. 7 graphically illustrates a simplified block diagram of a computing system for synthesizing product images from the product CAD models according to some embodiments of the present disclosure.

The present disclosure will now be described with reference to the accompanying drawings.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition does not in itself dictate a relationship between the various embodiments and/or configurations discussed.

Overview

Systems, methods, and apparatuses disclosed herein standardize product views of product images in the product catalog such that these products are displayed with substantially similar products views with respect to one another in the product catalog to enhance the visual appearance, or photorealism, of the product catalog. As such, the products within the same category of products, for example, the screws and bolts as described above, are illustrated in the product catalog with similar product views, for example, similar orientations, similar scales, and/or similar angles, with respect to one another. From the example above, even though the product CAD models can portray the products within the category of products using the standard right-side product view or the standard front-side product view, these systems, methods, and apparatuses standardize the product views of these products in the product catalog to be substantially uniform, for example, have substantially similar product views, with respect to one another to enhance the visual appearance, or photorealism, of the product catalog.

Exemplary Product Distribution Platform

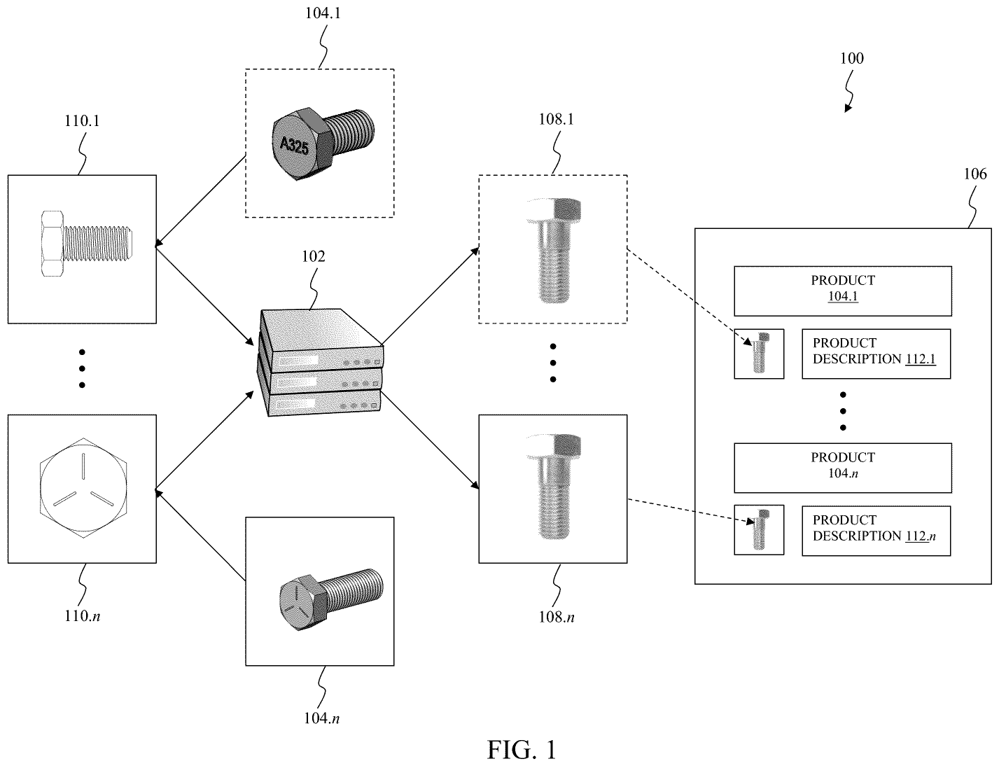

FIG. 1 illustrates a block diagram of an exemplary product distribution platform according to some embodiments of the present disclosure. As illustrated in FIG. 1, a product distribution platform 100 can be used by a product distributor to advertise products for sale to customers. These products can range from simple products such as screws and bolts to more complex products such as robotically controlled tools and workstations. Conventionally, manufacturers of products can generate three-dimensional computer-generated illustrations, also referred to as computer aided design (CAD) product models, for their products for display in a product catalog. And in some instances, the product distributor can generate the product CAD models itself. However, these product CAD models, whether generated by the manufacturers or the product distributor, can portray the products therein using different product views, for example, different orientations, different scales, different lighting, and/or different angles, with respect to one another. Herein, the terms orientation or the like describes a face of a product model that is visible to a virtual camera, which is to be described in further detail below. The terms orientation or the like can include a front product view, a back-side product view, a right-side product view, a left-side product view, a top-side product view, and a bottom-side product view to provide some examples. Herein, the terms angle or the like refer to a rotation of the product model along any coordinate axis of the Cartesian coordinate system, for example, a left or right rotation of the product model. The terms angle or the like can include a straight product view, a standard right product view, a top right product view, a standard left product view, and a top left product view to provide some examples. Those skilled in the relevant art(s) will recognize that a combination of orientation, for example the right-side product view, and angle, for example, the standard product view, can be used to determine a product view of the product being illustrated, such as a standard right-side product view to provide an example. Some product CAD models for products within a category of products, for example, screws and bolts, might portray these products using a standard right-side product view while other product CAD models for other products within the same category of products might portray these products using a standard bottom-top product view. As such, these product CAD models, if placed into product catalog, could drastically differ with respect to one another even if these products are within the same category of products. In the exemplary embodiment illustrated in FIG. 1, the distribution platform 100 can standardize product views of product images in the product catalog such that these products can be displayed with substantially similar products views with respect to one another in the product catalog to enhance the visual appearance, or photorealism, of the product catalog. As such, the products within the same category of products, for example, the screws and bolts as described above, can be illustrated in the product catalog with similar product views, for example, similar orientations, similar scales, and/or similar angles, with respect to one another. From the example above, even though the product CAD models can portray the products within the category of products using the standard right-side product view or the standard front-side product view, the distribution platform 100 can standardize the product views of these products in the product catalog to be substantially uniform, for example, have substantially similar product views, with respect to one another to enhance the visual appearance, or photorealism, of the product catalog.

As illustrated in FIG. 1, the distribution platform 100 can include an image rendering computing system 102, an example of which is to be described in further detail below, to synthesize images of products 104.1 through 104.n that are to be advertised for sale to customers in a product catalog 106. In the exemplary embodiment illustrated in FIG. 1, the image rendering computing system 102 can execute one or more graphical image rendering algorithms to synthesize product images 108.1 through 108.n from corresponding product CAD models from among product CAD models 110.1 through 110.n for the products 104.1 through 104. In some embodiments, the products 104.1 through 104.n can range from simple products such as screws and bolts to more complex products such as robotically controlled tools and workstations. In some embodiments, the one or more graphical image rendering algorithms can include one or more scanline rendering and rasterization algorithms, one or more ray casting algorithms, one or more ray tracing algorithms, one or more neural rendering algorithms, and/or any other suitable graphical image rendering algorithms that will be apparent to those skilled in the relevant art(s) without departing from the spirit and scope of the present disclosure. As to be described in further detail below, the one or more graphical image rendering algorithms, when executed by the image rendering computing system 102, can manipulate one or more parameters, characteristics, and/or attributes, for example, orientations, scales, lighting, and/or angles, of the product CAD models 110.1 through 110.n to synthesize the product images 108.1 through 108.n. In some embodiments, the one or more graphical image rendering algorithms, when executed by the image rendering computing system 102, can introduce one or more graphical image effects, such as shading, texture-mapping, bump-mapping, fogging, shadowing, reflecting, transparency, refracting, diffracting, illuminating, depth of field, motion blur, and/or non-photorealistic rendering to provide some examples, into the product CAD models 110.1 through 110.n while synthesizing the product images 108.1 through 108.n.

In the exemplary embodiment illustrated in FIG. 1, the product CAD models 110.1 through 110.n represent three-dimensional product models for the products 104.1 through 104.n in three-dimensional coordinates of a three-dimensional coordinate system, such as the x, y, and z coordinates of the Cartesian coordinate system to provide an example. For example, the product CAD model 110.1 represents a three-dimensional product model for the product 104.1 and the product CAD model 110.n represents a three-dimensional product model for the products 104.n. As described above, the product CAD models 110.1 through 110.n can portray the products 104.1 through 104.n using different product views, for example, different orientations, different scales, different lighting, and/or different angles, with respect to one another. For example, the product CAD model 110.1 can represent a standard right-side product view of the product 104.1 and the product CAD model 110.n can represent a standard front-side product view of the product 104.n. As such, the product CAD models 110.1 through 110.n, if placed into the product catalog 106, could drastically differ with respect to one another even if the products depicted within the product CAD models 110.1 through 110.n are within the same category of products. In some embodiments, the product CAD models 110.1 through 110.n can include suitable three-dimensional product models, such as three-dimensional wireframe product models, three-dimensional polygonal product models, three-dimensional solid product models, and/or three-dimensional surface product models to provide some details, that can be viewed from any orientation and/or angle in three-dimensional space that will be apparent to those skilled in the relevant art(s) without departing from the spirit and the scope of the present disclosure. In some embodiments, the product CAD models 110.1 through 110.n can include multiple product views of the products 104.1 through 104.n, such as a straight product view, a standard right product view, a top right product view, a standard left product view, and a top left product view to provide some examples. In these embodiments, the product CAD models 110.1 through 110.n typically illustrate one of these multiple product views of the products 104.1 through 104.n, such as the standard right-side product view to provide an example. As to be described in further detail below, the image rendering computing system 102 can manipulate the orientations and/or the angles of the three-dimensional product models for the products 104.1 through 104.n in three-dimensional coordinates of the three-dimensional coordinate system to depict another one of these multiple product views of the products 104.1 through 104.n, such as the standard left product view to provide an example, in the product CAD models 110.1 through 110.n when synthesizing the product images 108.1 through 108.n.

In some embodiments, the product CAD models 110.1 through 110.n can be stored as one or more digital CAD files that include the three-dimensional product models for the products 104.1 through 104.n as well as other information relating to these product models, such as manufacturers of the products 104.1 through 104.n, manufacturer part numbers assigned to the products 104.1 through 104.n, dimensions of the products 104.1 through 104.n, colors of the products 104.1 through 104.n, finishes of the products 104.1 through 104.n materials of the products 104.1 through 104.n, orientation of the product CAD models 110.1 through 110.n within the three-dimensional space, angles of the product CAD models 110.1 through 110.n within the three-dimensional space, reference markings, for example, faces or sides, on the product CAD models 110.1 through 110.n, coordinates of centers of the product CAD models 110.1 through 110.n within the three-dimensional space to provide some examples. In these embodiments, the other information can be stored as metadata within the digital CAD files that can be readable by the image rendering computing system 102. In these embodiments, these digital CAD files can be stored in a proprietary graphical file format such as a SolidWorks file format, a Autodesk Inventor file format, and/or a Solid Edge file format to provide some examples, or a non-proprietary graphical file format such as a Standard for the Exchange of Product Data (STEP) graphical file format, a Virtual Reality Modeling Language (VRML) graphical file format, an Initial Graphics Exchange Specification (IGES) graphical file format, a Drawing Exchange Format (DXF) graphical file format, a Stereo Lithography (STL) graphical file format, an XML based three-dimensional (X3D) graphical file format, and/or a Portable Document Format (PDF) graphical file format to provide some examples.

In the exemplary embodiment illustrated in FIG. 1, the product images 108.1 through 108.n represent three-dimensional images for the products 104.1 through 104.n in the three-dimensional coordinates of the three-dimensional coordinate system that are to be advertised for sale to customers in the product catalog 106. As described above, the product images 108.1 through 108.n can portray the products 104.1 through 104.n using substantially similar product views, for example, similar orientations, similar scales, and/or similar angles, with respect to one another. For example, the product image 108.1 and the product image 108.n can represent standard bottom-side product views of the product 104.1 and the product 104.n, respectively. As such, the product images 108.1 through 108.n when placed into the product catalog 106 are substantially uniform, for example, have substantially similar product views, with respect to one another. The product images 108.1 through 108.n can be stored in any suitable well-known image file format, such as Joint Photographic Experts Group (JPEG) image file format, Exchangeable Image File Format (EXIF), Tagged Image File Format (TIFF), Graphics Interchange Format (GIF), bitmap image file (BMP) format, or Portable Network Graphics (PNG) image file format to provide some examples, that will be apparent to those skilled in the relevant art(s) without departing from the spirit and scope of the present disclosure.

In the exemplary embodiment illustrated in FIG. 1, the product catalog 106 advertises the products 104.1 through 104.n for sale to customers. In some embodiments, the product catalog 106 can be, or included within, print media, such as a book, a business card, a brochure, a coupon, a magazine, a newspaper, a billboard, a postcard, and/or product packaging to provide some examples. Alternatively, or in addition to, the product catalog 106 can be, or incorporated within, digital media, such as a digital image, a digital video, a video game, a web page, a website, an electronic document, and and/or an electronic book to provide some examples. It should be noted that the product catalog 106 as illustrated in FIG. 1 is for exemplary purposes and is not limiting. Those skilled in the relevant art(s) will recognize that other configuration and arrangements are possible for the product catalog 106 without departing from the spirit and scope of the present disclosure. As illustrated in FIG. 1, the product catalog 106 identifies the products 104.1 through 104.n that are being advertised in the product catalog 106. In some embodiments, the products 112.1 through 112.n can be identified by manufacturer, manufacturer part number, a product identification label having an identification number or a barcode to provide some examples, in the product catalog 106. And as illustrated in FIG. 1, the product catalog 106 includes the product images 108.1 through 108.n and product descriptions 112.1 through 112.n for the products 104.1 through 104.n. In some embodiments, the product descriptions 112.1 through 112.n can describe various specifications, for example, dimensions, color, finish, material, performance characteristics, pricing, and/or packaging of the products 104.1 through 104.n. As illustrated in FIG. 1, the product images 108.1 through 108.n when placed into the product catalog 106 portray the products 104.1 through 104.n with substantial uniformity, for example, with substantially similar product views, with respect to one another image to enhance the visual appearance, or photorealism, of the product catalog 106. For example, the product image 108.1 and the product image 108.n can represent standard bottom-side product views of the product 104.1 and the product 104.n, respectively, as illustrated in the product catalog 106.

### Exemplary Image Rendering Computing System

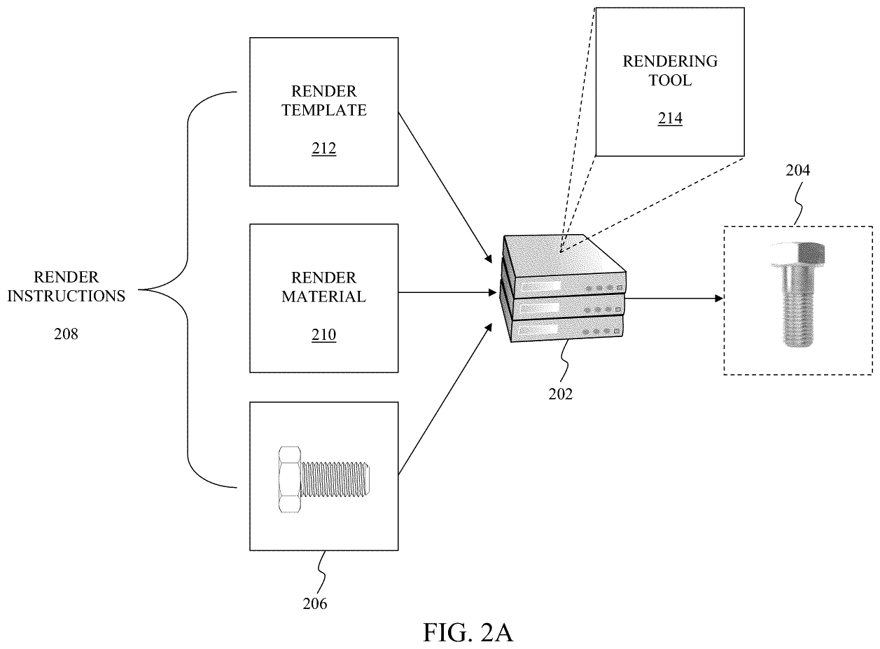

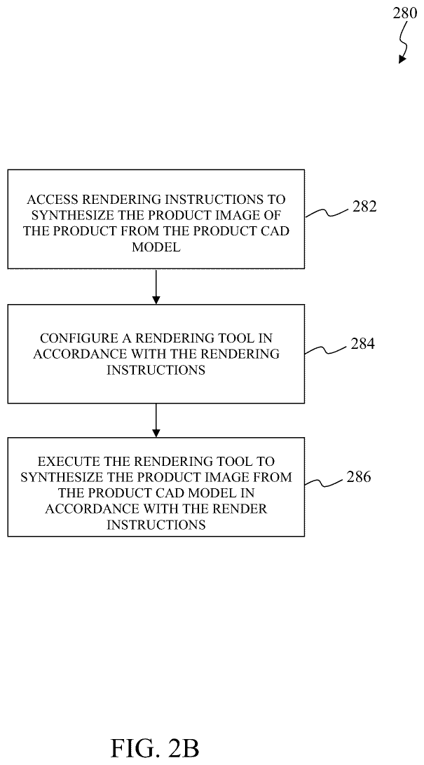

FIG. 2A illustrates a block diagram of an exemplary image rendering computing system that can be implemented within the exemplary product distribution platform according to some embodiments of the present disclosure. In the exemplary embodiment illustrated in FIG. 2A, the image rendering computing system 202 can synthesize a product image 204 for a product, such as the product 104.1 or the product 104.n as described above, from a product CAD model 206. In some embodiments, the image rendering computing system 202 can manipulate one or more parameters, characteristics, and/or attributes, for example, orientations, scales, lighting, and/or angles, of a product model, such as the product CAD model 206, when synthesizing the product image 204. In the exemplary embodiment illustrated in FIG. 2A, the product model can portray the product in the three-dimensional coordinates of the three-dimensional coordinate system in the three-dimensional space. As to be described in further detail below, the image rendering computing system 202 can manipulate the orientation and/or the angle of the product model in the three-dimensional coordinate system while synthesizing the product image 204. And as to be described in further detail below, the image rendering computing system 202 can manipulate the scale of the product model in the three-dimensional coordinate system while synthesizing the product image 204. Alternatively, or in addition to, the image rendering computing system 202 can introduce one or more graphical image effects, such as shading, texture-mapping, bump-mapping, fogging, shadowing, reflecting, transparency, refracting, diffracting, illuminating, depth of field, motion blur, and/or non-photorealistic rendering to provide some examples, onto the product model while synthesizing the product image 204. In some embodiments, the one or more graphical image effects can enhance the visual appearance, or photorealism, of the product image 204. The image rendering computing system 202 can represent an exemplary embodiment of the image rendering computing system 102 as described above.

As illustrated in FIG. 2A, the image rendering computing system 202 can synthesize a product image 204 of the product from a product CAD model 206 in accordance with render instructions 208. In some embodiments, the rendering instructions 208 can include the product CAD model 206, a render material 210, and a render template 212. The render material 210 describes one or more materials of the product that are to be synthesized by the image rendering computing system 202 onto the product model. In some embodiments, the one or more materials can include copper, steel, aluminum, black oxide, brass, bronze, carbide, plastic, cobalt steel, cork, and/or any other suitable material that will be apparent to those skilled in the relevant art(s) without departing from the spirit and scope of the present disclosure. The render template 212 describes a product view of the product to be depicted on the product image 204. In some embodiments, the product view of the product can include any suitable combination of an orientation, such as a front product view, a back-side product view, a right-side product view, a left-side product view, a top-side product view, and a bottom-side product view to provide some examples, and an angle, such as a straight product view, a standard right product view, a top right product view, a standard left product view, and a top left product view to provide some examples, that will be apparent to those skilled in the relevant art(s) without departing from the spirit and scope of the present disclosure.

As illustrated in FIG. 2A, the image rendering computing system 202 can include a rendering tool 214. In some embodiments, the image rendering computing system 202 can configure the rendering tool 214 to synthesize the product image 204 from the product CAD model 206 in accordance with the render instructions 208. The rendering tool 214 represents a software program, that when executed by the image rendering computing system 202, can synthesize the product image 204 from the product CAD model 206 in accordance with the render instructions 208. In some embodiments, the image rendering computing system 102 can include a central processing unit (CPU) and a graphics processing unit (GPU). In these embodiments, the CPU can execute the rendering tool 214, also referred to as CPU rendering, and/or the GPU can execute the rendering tool 214, also referred to as GPU rendering, to synthesize the product image 204 from the product CAD model 206 in accordance with the render instructions 208. In some embodiments, the rendering tool 214 can be implemented using an Autodesk 3ds Max computer graphics rendering software, a V-Ray computer graphics rendering software, a Lumion-3D computer graphics rendering software, a Maya computer graphics rendering software, a SketchUP computer graphics rendering software, a Corona-Render computer graphics rendering software, a Blender computer graphics rendering software, a Cinema-4D computer graphics rendering software, a Maxwell computer graphics rendering software, an Octane-Render computer graphics rendering software, a Autodesk-revit computer graphics rendering software, a ZBrush computer graphics rendering software, a Artlantis computer graphics rendering software, or any other well-known computer graphics rendering software that will be apparent to those skilled in the relevant art(s) without departing from the spirit and scope of the present disclosure.

Exemplary Operations of the Exemplary Image Rendering Computing System

FIG. 2B illustrates a flowchart of an exemplary operation of the exemplary image rendering computing system according to some exemplary embodiments of the present disclosure. The disclosure is not limited to this operational description. Rather, it will be apparent to ordinary persons skilled in the relevant art(s) that other operational control flows are within the scope and spirit of the present disclosure. An operational control flow 280 as illustrated in FIG. 2B can be executed by one or more computer systems, such as the image rendering computing system 102 and/or image rendering computing system 202 as described above to provide some examples. The following discussion is to describe an exemplary operational control flow 280 for synthesizing a product image for a product from a product CAD model, such as one or more of the product images 108.1 through 108.n from the product CAD models 110.1 through 110.n as described above and/or the product image 204 from the product CAD model 206 as described above.

At operation 282, the operational control flow 280 accesses rendering instructions to synthesize the product image of the product from the product CAD model. In some embodiments, the rendering instructions can include the product CAD model, a render material, and a render template. The render material describes one or more materials of the product that are to be synthesized by the operational control flow 280 onto the product model. In some embodiments, the one or more materials can include copper, steel, aluminum, black oxide, brass, bronze, carbide, plastic, cobalt steel, cork, and/or any other suitable material that will be apparent to those skilled in the relevant art(s) without departing from the spirit and scope of the present disclosure. The render template describes a product view of the product to be depicted on the product image. In some embodiments, the product view of the product can include any suitable combination of an orientation, such as a front product view, a back-side product view, a right-side product view, a left-side product view, a top-side product view, and a bottom-side product view to provide some examples, and an angle, such as a straight product view, a standard right product view, a top right product view, a standard left product view, and a top left product view to provide some examples, that will be apparent to those skilled in the relevant art(s) without departing from the spirit and scope of the present disclosure.

At operation 284, the operational control flow 280 configures a rendering tool to synthesize the product image from the product CAD model in accordance with the render instructions from operation 282. The rendering tool represents a software program, that when executed by the operational control flow 280, can synthesize the product image from the product CAD model in accordance with the render instructions from operation 282. In some embodiments, the rendering tool can be implemented using an Autodesk 3ds Max computer graphics rendering software, a V-Ray computer graphics rendering software, a Lumion-3D computer graphics rendering software, a Maya computer graphics rendering software, a SketchUP computer graphics rendering software, a Corona-Render computer graphics rendering software, a Blender computer graphics rendering software, a Cinema-4D computer graphics rendering software, a Maxwell computer graphics rendering software, an Octane-Render computer graphics rendering software, a Autodesk-revit computer graphics rendering software, a ZBrush computer graphics rendering software, a Artlantis computer graphics rendering software, or any other well-known computer graphics rendering software that will be apparent to those skilled in the relevant art(s) without departing from the spirit and scope of the present disclosure.

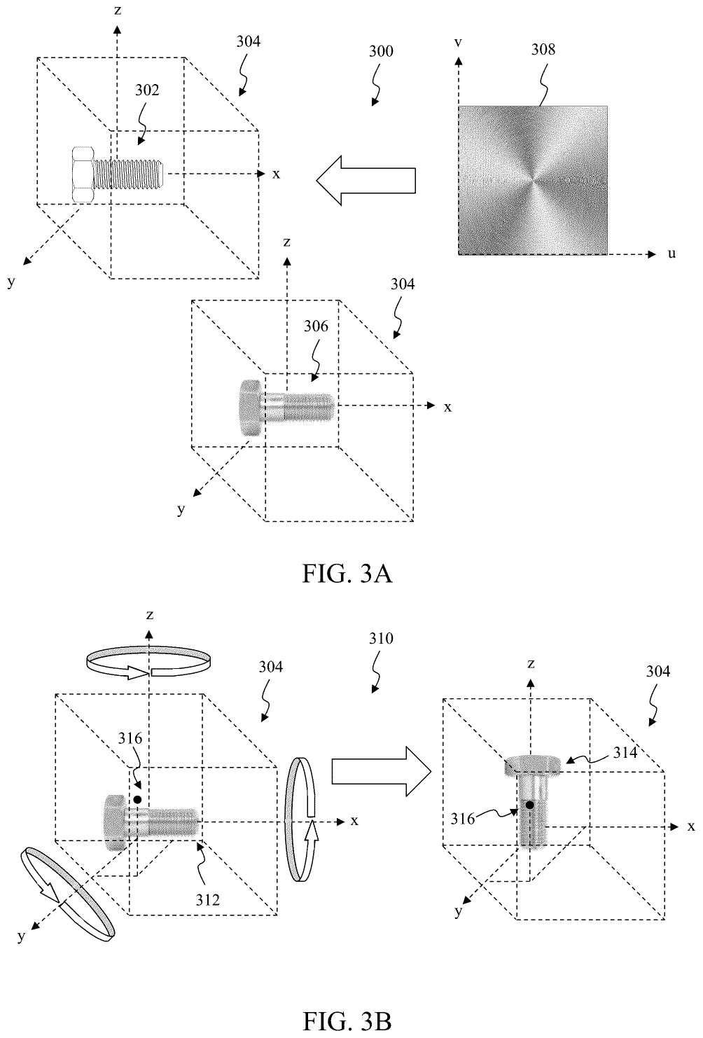

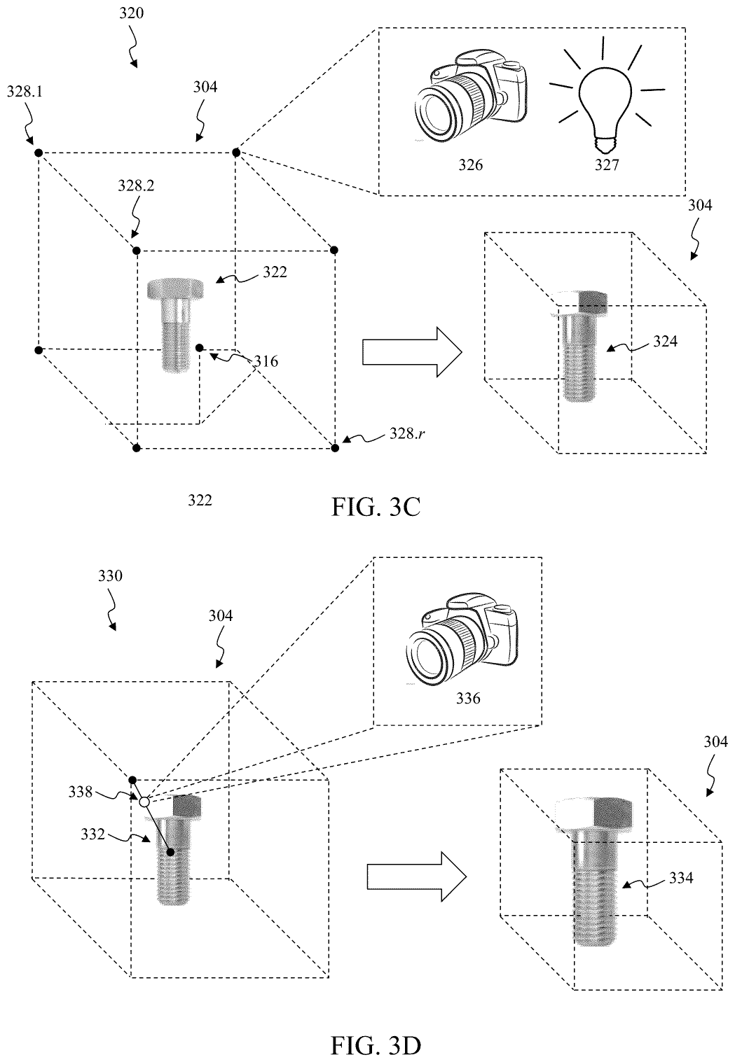

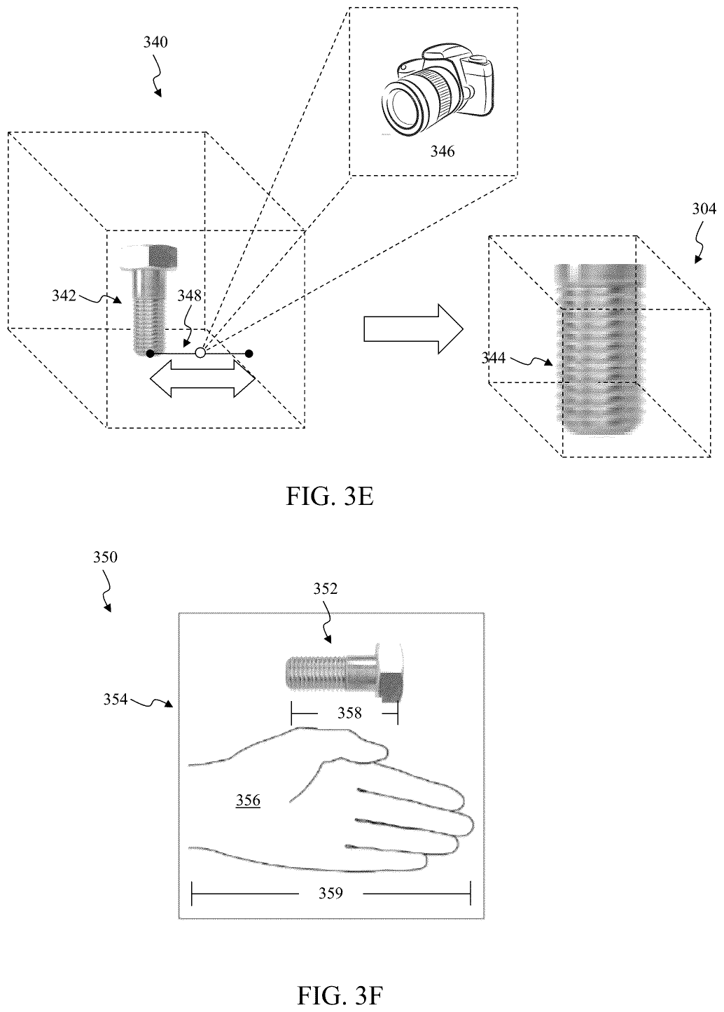

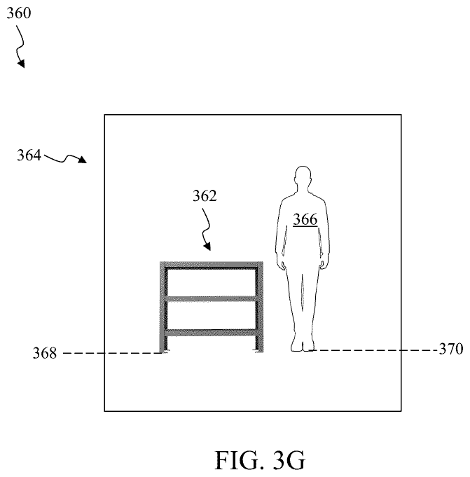

At operation 286, the operational control flow 280 executes the rendering tool from operation 284 to synthesize the product image from the product CAD model in accordance with the render instructions from operation 282. The operational control flow 280 can execute the rendering tool to manipulate one or more parameters, characteristics, and/or attributes, for example, orientations, scales, lighting, and/or angles, of the product model in the three-dimensional coordinate system while synthesizing the product image. Some non-limiting exemplary embodiments for these manipulations are to be described in further detail below in FIG. 3A through FIG. 3G. In some embodiments, the operational control flow 280 can execute the rendering tool to introduce one or more graphical image effects, such as shading, texture-mapping, bump-mapping, fogging, shadowing, reflecting, transparency, refracting, diffracting, illuminating, depth of field, motion blur, and/or non-photorealistic rendering to provide some examples, into the product CAD model while synthesizing the product image.

FIG. 3A through FIG. 3G graphically illustrate exemplary operations of the exemplary image rendering computing system according to some embodiments of the present disclosure. The exemplary operations to be described in further detail below can be performed by an image rendering computing system, such as the image rendering computing system 102 as described above and/or the image rendering computing system 202 as described above to provide some examples. In the discussion of FIG. 3A through FIG. 3G to follow, the image rendering computing system can perform a texture mapping operation 300 as illustrated in FIG. 3A, an orientation manipulation operation 310 as illustrated in FIG. 3B, a product view and illumination operation 320 as illustrated in FIG. 3C, a scaling operation 330 as illustrated in FIG. 3D, an image cropping operation 340 as illustrated in FIG. 3E, referencing operations 350 and 360 as illustrated in FIG. 3F and FIG. 3G, respectively, and/or any combination thereof to synthesize the product images 108.1 through 108.n from the product CAD models 110.1 through 110.n as described above and/or the product image 204 from the product CAD model 206 as described above. In some embodiments, the image rendering computing system can perform the texture mapping operation 300, the orientation manipulation operation 310, the product view and illumination operation 320, the scaling operation 330, the image cropping operation 340, the referencing operation 350, the referencing operation 360 and/or any combination thereof in a virtual rendering studio to synthesize the product images 108.1 through 108.n from the product CAD models 110.1 through 110.n as described above and/or the product image 204 from the product CAD model 206 as described above. In these embodiments, the virtual rendering studio represents a three-dimensional space that includes multiple virtual cameras arranged in the three-dimensional space. In these embodiments, the image rendering computing system can select one of these virtual cameras to depict a product view, such as a front product view, a back-side product view, a right-side product view, a left-side product view, a top-side product view, and a bottom-side product view to provide some examples, and an angle, such as a straight product view, a standard right product view, a top right product view, a standard left product view, and a top left product view to provide some examples, of a product. Alternatively, or in addition to, the virtual rendering studio can include virtual lighting to enhance the visual appearance, or photorealism, of the product view. In some embodiments, the image rendering computing system can retrieve the configuration and/or the arrangement of the virtual studio from rendering instructions, such as the rendering instructions 208 as described above. It should be noted that the operations to be described in further detail below in FIG. 3A through FIG. 3G can be repeated multiple occasions to provide multiple views of the product CAD models 110.1 through 110.n as described above and/or the product CAD model 206 as described above.

As illustrated in FIG. 3A, the image rendering computing system can import a computer-generated product model 302 of a product into a virtual rendering studio 304 to perform the texture mapping operation 300 onto the computer-generated product model 302 to synthesize a computer-generated product model 306. In some embodiments, the computer-generated product model 302 can represent any suitable three-dimensional product model that can be utilized by the image rendering computing system to the computer-generated product model 306. Although the virtual rendering studio 304 is illustrated as a cube in the three-dimensional space in FIG. 3A through FIG. 3G, this is for illustrative purposes only and is not intended to be limiting. Those skilled in the relevant art(s) will recognize that the virtual rendering studio 304 can arranged to be any three-dimensional shape in the three-dimensional space, such as a rectangular prism, a sphere, a cone, a cylinder, and/or any other suitable three-dimensional shape that will be apparent to those skilled in the relevant art(s) without departing from the spirit and scope of the present disclosure to provide some examples. In the exemplary embodiment illustrated in FIG. 3A, the image rendering computing system can map, or project, surface characteristics and/or appearance, for example, color, of one or more materials onto the computer-generated product model 302 in accordance with a user specified texture map 308 to introduce color, texture, or other surface characteristics, such as glossiness, reflectivity, or transparency to provide some examples, onto the computer-generated product model 302. In some embodiments, the image rendering computing system can perform a UV mapping of two-dimensional coordinates (u,v) of the user specified texture map 308 onto three-dimensional coordinates (x,y,z) of three-dimensional surfaces of the computer-generated product model 302 to synthesize the computer-generated product model 306. In some embodiments, the image rendering computing system can retrieve the user specified texture map 308 from rendering instructions, such as the rendering instructions 208 as described above. In these embodiments, the rendering instructions can include a render material, such as the render material 210 as described above to provide an example, that identifies the one or more materials of the user specified texture map 308 and the color, the texture, or the other surface characteristics, such as glossiness, reflectivity, or transparency to provide some examples, of the one or more materials identified in the render material.

As illustrated in FIG. 3B, the image rendering computing system can import a computer-generated product model 312 of the product into the virtual rendering studio 304 to perform the orientation manipulation operation 310 onto the computer-generated product model 312 to synthesize a computer-generated product model 314. In some embodiments, the computer-generated product model 312 can represent any suitable three-dimensional product model that can be utilized by the image rendering computing system to synthesize the computer-generated product model 314. The image rendering computing system can manipulate the orientation and/or the angle of the computer-generated product model 312 in the three-dimensional coordinate space from an initial product view as illustrated in the left side of FIG. 3B to a desired product view as illustrated in the right side of FIG. 3B while synthesizing the computer-generated product model 314. In some embodiments, the image rendering computing system can identify the initial product view of the computer-generated product model 312 in the three-dimensional space. In some embodiments, the computer-generated product model 312 can be from a digital CAD file that can specify the product view of the computer-generated product model 312 depicted in the digital CAD file. For example, the initial product view of the computer-generated product model 312 can be stored as metadata in the digital CAD file that can be retrieved by the image rendering computing system. In some embodiments, the image rendering computing system can identify the initial product view of the computer-generated product model 312 by comparing the product view of the computer-generated product model 312 depicted in the digital CAD file with known product views of the product and/or similar products.

In these embodiments, the image rendering computing system can rotate the computer-generated product model 312 along the x, y, and/or z coordinates of the Cartesian coordinate system to rotate the computer-generated product model 312 from the initial product view to the desired product view to synthesize the computer-generated product model 314. In some embodiments, the image rendering computing system can identify at least two product views of the computer-generated product model 312 within the three-dimensional space, for example, two or more of a front product view, a back-side product view, a right-side product view, a left-side product view, a top-side product view, or a bottom-side product view, that are oriented along the X-Y plane of the Cartesian coordinate system and the X-Z plane of the Cartesian coordinate system in the three-dimensional space. With these two product views of the computer-generated product model 312 being identified, the image rendering computing system can identify one or more other product views of the computer-generated product model 312, for example, one or more of a front product view, a back-side product view, a right-side product view, a left-side product view, a top-side product view, or a bottom-side product view, in the three-dimensional space.

In the exemplary embodiment illustrated in FIG. 3B, with the at least two product views of the computer-generated product model 312 being identified in the three-dimensional space, the image rendering computing system can thereafter rotate the computer-generated product model 312 along the x, y, and/or z coordinates of the Cartesian coordinate system to orient the computer-generated product model 312 from the initial product view to the desired product view to synthesize the computer-generated product model 314. In some embodiments, the image rendering computing system can rotate the computer-generated product model 312 along the x, y, and/or z coordinates of the Cartesian coordinate system to align the desired product view with a reference point 316 that is associated with the desired product view in the three-dimensional space. Alternatively, or in addition to, the image rendering computing system can rotate the computer-generated product model 312 along the x, y, and/or z coordinates of the Cartesian coordinate system to orient the computer-generated product model 312 to a default product view, such as a front product view, a back-side product view, a right-side product view, a left-side product view, a top-side product view, or a bottom-side product view, and can thereafter once again rotate the computer-generated product model 312 along the x, y, and/or z coordinates of the Cartesian coordinate system to orient the computer-generated product model 312 from the default product view to the desired product view. In some embodiments, the image rendering computing system can rotate the computer-generated product model 312 along the x, y, and/or z coordinates of the Cartesian coordinate system to match the product view being depicted in the computer-generated product model 314 to the product view that is associated with the reference point 316.

In some embodiments, the image rendering computing system can retrieve the desired product view, the first product view, the second product view, and/or the reference point 316 in the three-dimensional space from the rendering instructions, such as the rendering instructions 208 as described above. In these embodiments, the rendering instructions can include a render template, such as the render template 212 as described above to provide an example, that describes the reference point 316 in terms of a position, for example, height of a virtual camera within the three-dimensional coordinate system and the desired product view identifying an orientation and/or angle of the computer-generated product model 314 that is be visible to the virtual camera.

As illustrated in FIG. 3C, the image rendering computing system can import a computer-generated product model 322 of the product in the virtual rendering studio 304 to perform the product view and illumination operation 320 onto the computer-generated product model 322 to synthesize a computer-generated product model 324. In some embodiments, the computer-generated product model 322 can represent any suitable three-dimensional product model that can be utilized by the image rendering computing system to synthesize the computer-generated product model 324. In the exemplary embodiment illustrated in FIG. 3C, the virtual rendering studio 304 can include multiple virtual cameras 326 and/or multiple virtual lighting sources 327 arranged about vertices 328.1 through 328.r of the virtual rendering studio 304 in the three dimensional space. However, the arrangement of the multiple virtual cameras 326 and/or the multiple virtual lighting sources 327 about the vertices 328.1 through 328.r is illustrative purposes only and are not intended to be limiting. Those skilled in the relevant art(s) will recognize that other arrangement of the multiple virtual cameras 326 and/or the multiple virtual lighting sources 327, for example, about edges and/or faces of the virtual rendering studio 304, are possible without departing from the spirit and scope of the present disclosure. In the exemplary embodiment illustrated in FIG. 3C, the virtual image rendering computing system can select one of the multiple virtual cameras 326 arranged about the vertices 328.1 through 328.r to depict a product view, such as a front product view, a back-side product view, a right-side product view, a left-side product view, a top-side product view, and a bottom-side product view to provide some examples, for the computer-generated product model 324. In some embodiments, the orientation manipulation operation 310 above effectively aligns the product views of the computer-generated product model 322 to the multiple virtual cameras 326 and/or multiple virtual lighting sources 327 arranged about vertices 328.1 through 328.r of the virtual rendering studio 304 in the three dimensional space. In these embodiments, the image rendering computing system can select the virtual camera 326 arranged about the vertex 328.2 that is aligned, for example, most proximate to, the reference point 316 in the three-dimensional space to depict a top left bottom-side product view of the computer-generated product model 322 for the computer-generated product model 324. In some embodiments, the image rendering computing system preferably selects one of the virtual cameras about the vertices 328.1 through 328.r that effectively looks down on the computer-generated product model 322. In the exemplary embodiment illustrated in FIG. 3C, each of the multiple virtual cameras 326 can be mapped, or assigned, to one or more of the virtual lighting sources 327 arranged about the vertices 328.1 through 328.r of the virtual rendering studio 304. In some embodiments, the image rendering computing system can select the virtual lighting sources 327 arranged about the vertex 328.2 that has been assigned to the selected camera to enhance the visual appearance, or photorealism, of the computer-generated product model 324.

As illustrated in FIG. 3D, the image rendering computing system can import a computer-generated product model 332 of the product in the virtual rendering studio 304 to perform the scaling operation 330 onto the computer-generated product model 332 to synthesize a computer-generated product model 334. In some embodiments, the computer-generated product model 332 can represent any suitable three-dimensional product model that can be utilized by the image rendering computing system to synthesize the computer-generated product model 334. In the exemplary embodiment illustrated in FIG. 3D, the image rendering computing system can move a virtual camera 336 to be closer to the computer-generated product model 332 to zoom into the computer-generated product model 332 to synthesize the computer-generated product model 334 that is larger, for example, occupies more volume, than the computer-generated product model 332. Alternatively, or in addition to, image rendering computing system can move the virtual camera 336 to be further from the computer-generated product model 332 to zoom out of the computer-generated product model 332 to synthesize the computer-generated product model 334 that is smaller, for example, occupies less volume, than the computer-generated product model 332. In the exemplary embodiment illustrated in FIG. 3D, the image rendering computing system can translate the virtual camera 336 along a virtual line that extends from an initial location of the virtual camera 336 within the virtual rendering studio 304, for example, a vertex of the virtual rendering studio 304, to a central reference point of the computer-generated product model 332. In some embodiments, the computer-generated product model 332 can be from a digital CAD file that can include three-dimensional coordinates of the central reference point of the computer-generated product model 332. In these embodiments, the image rendering computing system can retrieve the central reference point of the computer-generated product model 332 from the digital CAD file. For example, the central reference point of the computer-generated product model 332 can be stored as metadata in the digital CAD file that can be retrieved by the image rendering computing system. In the exemplary embodiment illustrated in FIG. 3D, the image rendering computing system can zoom into and/or zoom out of the computer-generated product model 332 until the product model occupies a significant portion, for example, more than ninety (90) precent, of the computer-generated product model 334.

As illustrated in FIG. 3E, the image rendering computing system can import a computer-generated product model 342 of the product in the virtual rendering studio 304 to perform the image cropping operation 340 onto the computer-generated product model 342 to synthesize a computer-generated product model 344. In some embodiments, the computer-generated product model 342 can represent any suitable three-dimensional product model that can be utilized by the image rendering computing system to synthesize the computer-generated product model 344. The image cropping operation 340 as illustrated in FIG. 3E is substantially similar to the scaling operation 330 as illustrated in FIG. 3D above. However, instead of translating the virtual camera 336 along the virtual line that extends to the central reference point of the computer-generated product model 332 as illustrated in FIG. 3D, the image rendering computing system translates a virtual camera 346 along a virtual line that extends from an initial location of a virtual camera 346 to any three-dimensional reference point of the computer-generated product model 342 as illustrated in FIG. 3E. Thereafter, the image rendering computing system can zoom into and/or zoom out of the computer-generated product model 342 until the product model occupies a significant portion, for example, more than ninety (90) precent, of the computer-generated product model 344.

In some embodiments, the three-dimensional reference point of the computer-generated product model 342 can be situated along an edge of the computer-generated product model 342 to implement an edge crop. In these embodiments, the image rendering computing system identifies two central reference points of two different faces of the computer-generated product model 342 along the longest dimension of the computer-generated product model 342. In these embodiments, the image rendering computing system places a virtual line between these two central reference points and thereafter situates the three-dimensional reference point along the virtual line from one of the two faces at approximately a distance that is related to the smallest dimension of the computer-generated product model 342 to implement the edge crop of the computer-generated product model 342. In some embodiments, the three-dimensional reference point of the computer-generated product model 342 can be situated along a corner of the computer-generated product model 342 to implement a corner crop. In these embodiments, the image rendering computing system identifies a corner of the computer-generated product model 342. In these embodiments, the image rendering computing system situates the three-dimensional reference point from the corner by an amount related to the median dimension in the indices of the maximum and median dimensions of the computer-generated product model 342 to implement the corner crop of the computer-generated product model 342.

As illustrated in FIG. 3F, the image rendering computing system can import a computer-generated product model 352 of the product in the virtual rendering studio 304 to perform the referencing operation 350 onto the computer-generated product model 352 to synthesize a computer-generated product model 354. In some embodiments, the computer-generated product model 352 can represent any suitable three-dimensional product model that can be utilized by the image rendering computing system to synthesize the computer-generated product model 354. In the exemplary embodiment illustrated in FIG. 3F, the image rendering computing system can select a reference image 356 from among a catalog of reference images based upon dimensions of the referencing operation 350. In some embodiments, the computer-generated product model 352 can be from a digital CAD file that can include various dimensions of the computer-generated product model 352. In these embodiments, the image rendering computing system can retrieve the dimensions of the computer-generated product model 352 from the digital CAD file. In some embodiments, the image rendering computing system can identify a longest dimension 358 of the computer-generated product model 352 from the dimensions of the computer-generated product model 352. For example, the dimensions of the computer-generated product model 352 can be stored as metadata in the digital CAD file that can be retrieved by the image rendering computing system. In some embodiments, the catalog of reference images can include digital CAD files of an image of a person, an image of a hand of the person, and an image of a finger of the hand of the person to provide some examples. In the exemplary embodiment illustrated in FIG. 3F, the computer-generated product model 352 can manipulate the orientation and/or the angle of the computer-generated product model 312 in the three-dimensional coordinate space in a substantially similar manner as described above to align the longest dimension 358 of the computer-generated product model 352 and a longest dimension 359 of the reference image 356. In some embodiments, the computer-generated product model 352 can identify a longest dimension 359 of the reference image 356. In these embodiments, the computer-generated product model 352 can align the longest dimension 358 of the computer-generated product model 352 to be parallel to the longest dimension 359 of the reference image 356 as illustrated in FIG. 3F.

As illustrated in FIG. 3G, the image rendering computing system can import a computer-generated product model 362 of the product, for example, a steel table, in the virtual rendering studio 304 to perform the referencing operation 360 onto the computer-generated product model 362 to synthesize a computer-generated product model 364. In some embodiments, the computer-generated product model 362 can represent any suitable three-dimensional product model that can be utilized by the image rendering computing system to synthesize the computer-generated product model 364. In the exemplary embodiment illustrated in FIG. 3G, the image rendering computing system can select a reference image 366 from among the catalog of reference images, as described above, based upon dimensions of the referencing operation 360 in a substantially similar manner as described above. In some embodiments, the computer-generated product model 362 can be from a digital CAD file that can include various dimensions of the computer-generated product model 362. In these embodiments, the image rendering computing system can retrieve the dimensions, the orientation, and/or the angle of the computer-generated product model 362 from the digital CAD file. For example, the dimensions of the computer-generated product model 362 can be stored as metadata in the digital CAD file that can be retrieved by the image rendering computing system. As another example, the orientation, and/or the angle of the computer-generated product model 362, such a front product view, a back-side product view, a right-side product view, a left-side product view, a top-side product view, and a bottom-side product view to provide some examples, can be stored as metadata in the digital CAD file that can be retrieved by the image rendering computing system. In this other example, the image rendering computing system can identify a “natural” bottom 368 of the computer-generated product model 362 from the orientation, and/or the angle of the computer-generated product model 362. In some embodiments, the catalog of reference images can include an image of a person, an image of a hand of the person, and an image of a finger of the hand of the person to provide some examples. In these embodiments, the catalog of reference images can identify the orientation, and/or the angle of these reference images, such a front product view, a back-side product view, a right-side product view, a left-side product view, a top-side product view, and a bottom-side product view to provide some examples. In the exemplary embodiment illustrated in FIG. 3G, the computer-generated product model 362 can manipulate the orientation and/or the angle of the computer-generated product model 312 in the three-dimensional coordinate space in a substantially similar manner as described above to align the “natural” bottom 368 of the computer-generated product model 362 and a “natural” bottom 370 of the reference image 366. In some embodiments, the computer-generated product model 362 can identify and the “natural” bottom 370 of the reference image 366 from the digital CAD files of the catalog of reference images. In these embodiments, the computer-generated product model 362 can align the “natural” bottom 368 of the computer-generated product model 362 to be parallel to the “natural” bottom 370 of the reference image 366 as illustrated in FIG. 3G.

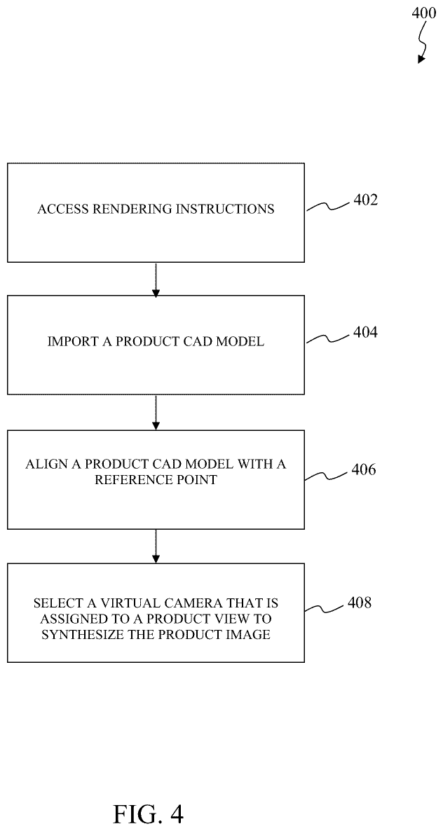

FIG. 4 illustrates a flowchart of an exemplary operation of the exemplary image rendering computing system to synthesize the product image of the product utilizing the exemplary operations of the exemplary image rendering computing system according to some embodiments of the present disclosure. The disclosure is not limited to this operational description. Rather, it will be apparent to ordinary persons skilled in the relevant art(s) that other operational control flows are within the scope and spirit of the present disclosure. An operational control flow 400 as illustrated in FIG. 4 can be executed by one or more computer systems, such as the image rendering computing system 102 and/or image rendering computing system 202 as described above to provide some examples. The following discussion is to describe an exemplary operational control flow 400 for synthesizing a product image for a product from a product CAD model, such as one or more of the product images 108.1 through 108.n from the product CAD models 110.1 through 110.n as described above and/or the product image 204 from the product CAD model 206 as described above. The operational control flow 400 can include the virtual rendering studio as described above to synthesize the product image as to be described in further detail below in FIG. 4. In some embodiments, the virtual rendering studio represents a three-dimensional space that includes multiple virtual cameras arranged in the three-dimensional space.

At operation 402, the operational control flow 400 accesses rendering instructions to synthesize the product image for the product from the product CAD model. In some embodiments, the rendering instructions can include the product CAD model, a render material, and a render template. The render material describes one or more materials of the product that are to be synthesized by the image rendering computing system 202 onto the product model. In some embodiments, the one or more materials can include copper, steel, aluminum, black oxide, brass, bronze, carbide, plastic, cobalt steel, cork, and/or any other suitable material that will be apparent to those skilled in the relevant art(s) without departing from the spirit and scope of the present disclosure. The render template describes a product view of the product to be depicted on the product image. In some embodiments, the render template can describe a reference point for synthesizing the product image and a product view, such as a front product view, a back-side product view, a right-side product view, a left-side product view, a top-side product view, and a bottom-side product view to provide some examples, and an angle, such as a straight product view, a standard right product view, a top right product view, a standard left product view, and a top left product view to provide some examples, for the product image. In these embodiments, the reference point can be described in terms of a position within a three-dimensional coordinate system.

At operation 404, the operational control flow 400 imports the product CAD model from operation 402. In some embodiments, the operational control flow 400 can perform the texture mapping operation 300 as described above to map, or project, surface characteristics and/or appearance, for example, color, of one or more materials onto the product CAD model in accordance with the render material from operation 402. In some embodiments, the operational control flow 400 can introduce color, texture, or other surface characteristics, such as glossiness, reflectivity, or transparency to provide some examples, onto the product CAD model. In some embodiments, the operational control flow 400 can perform a UV mapping of two-dimensional coordinates (u,v) of the render material from operation 402 onto three-dimensional coordinates (x,y,z) of three-dimensional surfaces of the product CAD model.

At operation 406, the operational control flow 400 aligns the product CAD model with the reference point from operation 402. In some embodiments, the operational control flow 400 can perform the orientation manipulation operation 310 as described above to manipulate the orientation and/or the angle of the product CAD model in the three-dimensional space to match the product view of the product CAD model depicted in the product image to be the product view from operation 402. In these embodiments, the operational control flow 400 can rotate the product CAD model along the x, y, and/or z coordinates of the Cartesian coordinate system to rotate the product CAD model in the three-dimensional coordinate space. In some embodiments, the reference point from operation 402 can be associated with the product view from operation 402, such as the standard right-side product view to provide an example. In these embodiments, the operational control flow 400 system can identify at least two product views of the product CAD model within the three-dimensional space, for example, two or more of a front product view, a back-side product view, a right-side product view, a left-side product view, a top-side product view, or a bottom-side product view, from the product CAD model from operation 402. For example, the operational control flow 400 system can identify at least two product views of the product CAD model that are oriented along the X-Y plane of the Cartesian coordinate system and the X-Z plane of the Cartesian coordinate system in the three-dimensional space from, for example, metadata in the product CAD model. With these two product views of the product CAD model being identified, the image rendering computing system can thereafter rotate the product CAD model along the x, y, and/or z coordinates of the Cartesian coordinate system to match the product view of the product CAD model being depicted in the product image to be the product view from operation 402 that is associated with the reference point from operation 402.

At operation 408, the operational control flow 400 selects a virtual camera from among the virtual cameras within virtual rendering studio that is assigned to the product view from operation 402. In some embodiments, the operational control flow 400 can perform the product view and illumination operation 320 to select one of the virtual cameras within virtual rendering studio to synthesize the product image for the product having the product view from operation 402. In these embodiments, the virtual cameras within virtual rendering studio can be mapped, or assigned a front product view, a back-side product view, a right-side product view, a left-side product view, a top-side product view, and/or a bottom-side product view, among others, for the product CAD model. In these embodiments, the alignment the product CAD model with the reference point from operation 402 performed at operation 406 aligns the different product views of the product CAD model and the different product views of the virtual cameras within virtual rendering studio. In these embodiments, the operational control flow 400 selects the virtual camera from among the virtual cameras within virtual rendering studio that is assigned to the product view from operation 402 to synthesize the product image for the product having the product view from operation 402 to synthesize the product image for the product having the product view from operation 402.

Exemplary Product Cad Models that can be Utilized within the Exemplary Product Distribution Platform

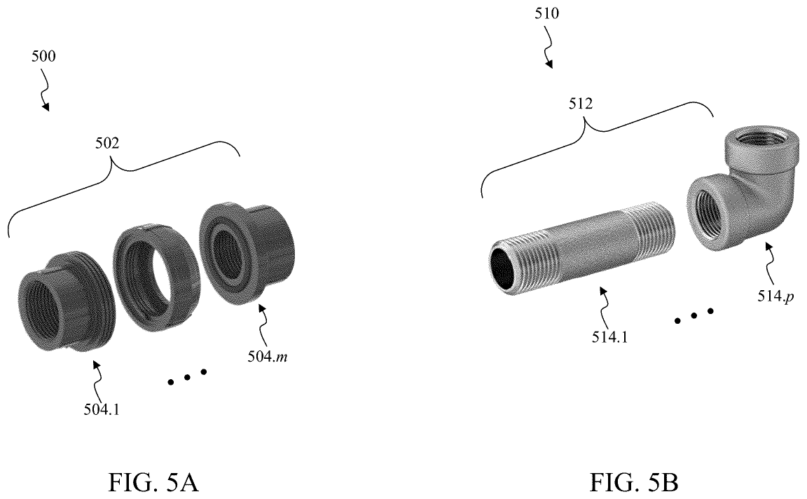

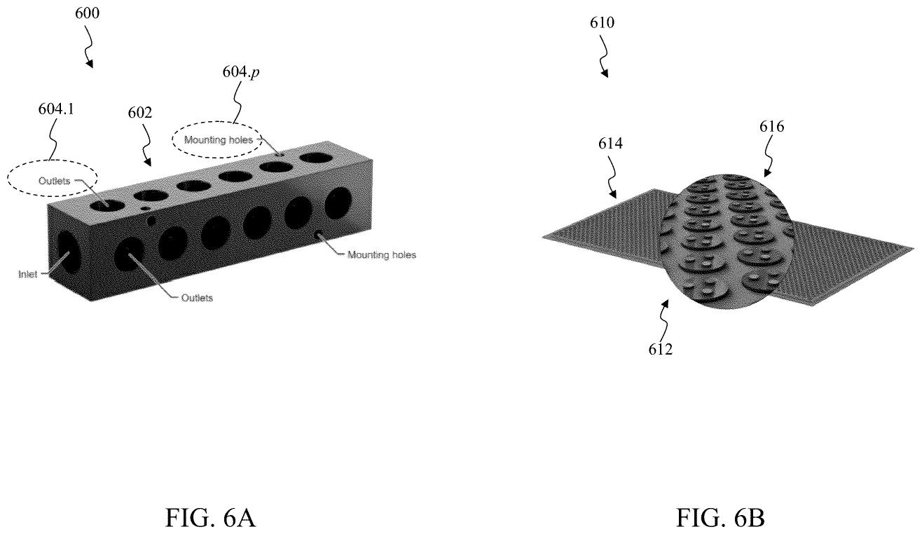

The exemplary embodiments described above can synthesize various product images for various products from various product CAD models. The discussion of FIG. 5A, FIG. 5B, FIG. 6A, and FIG. 6B to follow is to describe some exemplary embodiments for these various product CAD models and/or product images. However, the exemplary embodiments to be described in FIG. 5A, FIG. 5B, FIG. 6A, and FIG. 6B are not limiting. Those skilled in the relevant art(s) will recognize that other product CAD models and/or other product images are possible without departing from the spirit and scope of the present disclosure. FIG. 5A and FIG. 5B graphically illustrate exemplary product computer aided design (CAD) models that can be utilized within the exemplary product distribution platform according to some embodiments of the present disclosure. FIG. 5A graphically illustrates a product CAD model 500 of a three-dimensional product model of a product 502 having multiple components 504.1 through 504.m. In some embodiments, the multiple components 504.1 through 504.m can be within the same category of products, for example, the Acrylonitrile Butadiene Styrene (ABS) pipe connections as illustrated in FIG. 5A. Alternatively, or in addition to, the multiple components 504.1 through 504.m can be within complementary categories of products, for example, nuts, washers, and/or bolts. As illustrated in FIG. 5A, the multiple components 504.1 through 504.m can be depicted in the product CAD model 500 as being separated, or ungrouped, and shown at a distance from one another within the three-dimensional space. In some embodiments, the product CAD model 500 can be stored as the one or more digital CAD files that include a three-dimensional product model for the product 502 as well as the other information relating to this three-dimensional product model as described above. In these embodiments, the other information can further include an expansion axis, such as any coordinate axis of the Cartesian coordinate system to provide an example, upon which to separate the three-dimensional product model for the product 502. In the exemplary embodiment illustrated in FIG. 5A, the various exemplary rendering computing systems as described above can further deconstruct the three-dimensional product model for the product 502 to separate, or ungroup, three-dimensional product model for the product 502 along the expansion axis within the three-dimensional space to include the multiple components 504.1 through 504.m in the product CAD model 500. Thereafter, these exemplary rendering computing systems as described above can synthesize various product images of the multiple components 504.1 through 504.m from the product CAD model 500 in a substantially similar manner as described above.

FIG. 5B graphically illustrates a product CAD model 510 of a three-dimensional product model of a product 512 having multiple products 514.1 through 514.p. In some embodiments, the multiple products 514.1 through 514.p can be within the same category of products, for example, the cast iron pipe and the cast iron pipe connection as illustrated in FIG. 5B. Alternatively, or in addition to, the multiple products 514.1 through 514.p can be within complementary categories of products, for example, nuts, washers, and/or bolts. As illustrated in FIG. 5B, the multiple products 514.1 through 514.p can be depicted in the product CAD model 510 as being combined, or grouped, to form the product 512 and shown at a distance from one another within the three-dimensional space. In some embodiments, the product CAD model 510 can be stored as the one or more digital CAD files that include a three-dimensional product model for the product 512 as well as the other information relating to this three-dimensional product model as described above. In these embodiments, the other information can further include the expansion axis, as described above, upon which to combine the multiple products 514.1 through 514.p. In the exemplary embodiment illustrated in FIG. 5B, the various exemplary rendering computing systems as described above can further combine, or group, the multiple products 514.1 through 514.p to construct the three-dimensional product model for the product 512 along the expansion axis within the three-dimensional space. Thereafter, these exemplary rendering computing systems as described above can synthesize various product images products of the product 512 from the product CAD model 510 in a substantially similar manner as described above.

Exemplary Product Images that can be Synthesized by the Exemplary Product Distribution Platform

FIG. 6A and FIG. 6B graphically illustrate exemplary product images that can be synthesized by the exemplary product distribution platform according to some embodiments of the present disclosure. FIG. 6A graphically illustrates a product image 600 of a three-dimensional product model of a product 602, such as a manifold to provide an example. In the exemplary embodiment illustrated in FIG. 6A, the various exemplary rendering computing systems as described above can synthesize the product image 600 from a product CAD model of the product 602 in a substantially similar manner as described above. Thereafter, these exemplary rendering computing systems can further annotate the product 602 in the product image 600 to highlight various characteristics, attributes, elements, features, or the like of the product 602 in the product image 600. In some embodiments, these exemplary rendering computing systems can annotate the various characteristics, attributes, elements, features, or the like of the product 602 in the product image 600 using textual reference labels 604.1 through 604.p. In these embodiments, the textual reference labels 604.1 through 604.p can be associated with leadlines, such as lines or arrows to provide some examples, to identify the various characteristics, attributes, elements, features, or the like of the product 602 that are annotated by the textual reference labels 604.1 through 604.p. For example, the product image 600 for the manifold as illustrated in FIG. 6 can be annotated to include textual reference labels for outlets, mounting holes, and an inlet as illustrated in FIG. 6A.

FIG. 6B graphically illustrates a product image 610 of a three-dimensional product model of a product 612, such an anti-fatigue floor mat to provide an example. In the exemplary embodiment illustrated in FIG. 6A, the various exemplary rendering computing systems as described above can synthesize a first product image 614 from a product CAD model of the product 612 in a substantially similar manner as described above. And these exemplary rendering computing systems as described above can synthesize a second product image 616 from the product CAD model of the product 612 in a substantially similar manner as described above. Thereafter, these exemplary rendering computing systems can merge the first product image 614 and the second product image 614 to synthesize the product image 610 as illustrated in FIG. 6B. For example, in the exemplary embodiment illustrated in FIG. 6A, these exemplary rendering computing systems can perform the texture mapping operation 300 as illustrated in FIG. 3A, the orientation manipulation operation 310 as illustrated in FIG. 3B, the product view and illumination operation 320 as illustrated in FIG. 3C, and/or the scaling operation 330 as illustrated in FIG. 3D on the product CAD model of the product 612 to synthesize a first product image 614. In this example, these exemplary rendering computing systems can perform the image cropping operation 340 as illustrated in FIG. 3E on the first product image 614 to synthesize the second product image 616. In this example, these exemplary rendering computing systems can merge the first product image 614 and the second product image 614 to synthesize the product image 610 illustrating a zoomed-in region of the anti-fatigue floor mat as illustrated in FIG. 6B.

Computing System for Executing the Design Environment

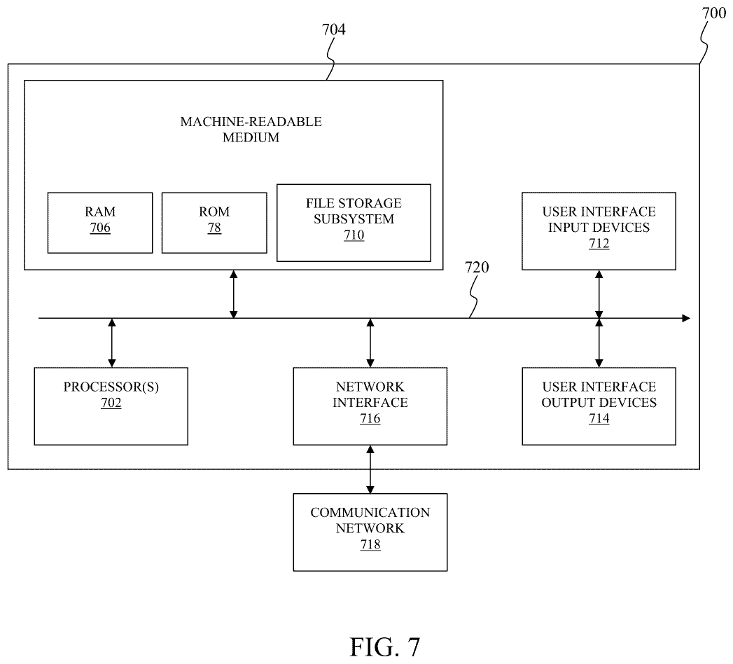

FIG. 7 graphically illustrates a simplified block diagram of a computing system for synthesizing product images from the product CAD models according to some embodiments of the present disclosure. As described above, the image rendering computing system 102 as described above and/or the image rendering computing system 202 as described above to provide some examples can synthesize the product images 108.1 through 108.n from the product CAD models 110.1 through 110.n as described above and/or the product image 207 from the product CAD model 206 as described above. The discussion of FIG. 7 to follow is to describe a computing system 700 that can be used to implement the image rendering computing system 102 as described above and/or the image rendering computing system 202 as described above to provide some examples.

In the embodiment illustrated in FIG. 7, the computing system 700 includes one or more processors 702 to synthesize the product images 108.1 through 108.n from the product CAD models 110.1 through 110.n as described above and/or the product image 204 from the product CAD model 206 as described above. In some embodiments, the one or more processors 702 can include, or can be, any of a microprocessor, graphics processing unit, or digital signal processor, and their electronic processing equivalents, such as an Application Specific Integrated Circuit (“ASIC”) or Field Programmable Gate Array (“FPGA”). As used herein, the term “processor” signifies a tangible data and information processing device that physically transforms data and information, typically using a sequence transformation (also referred to as “operations”). Data and information can be physically represented by an electrical, magnetic, optical or acoustical signal that is capable of being stored, accessed, transferred, combined, compared, or otherwise manipulated by the processor. The term “processor” can signify a singular processor and multi-core systems or multi-processor arrays, including graphic processing units, digital signal processors, digital processors or combinations of these elements. The processor can be electronic, for example, comprising digital logic circuitry (for example, binary logic), or analog (for example, an operational amplifier). The processor may also operate to support performance of the relevant operations in a “cloud computing” environment or as a “software as a service” (SaaS). For example, at least some of the operations may be performed by a group of processors available at a distributed or remote system, these processors accessible via a communications network (e.g., the Internet) and via one or more software interfaces (e.g., an application program interface (API).) In some embodiments, the computing system 700 can include an operating system, such as Microsoft's Windows, Sun Microsystems's Solaris, Apple Computer's MacOs, Linux or UNIX. In some embodiments, the computing system 700 can also include a Basic Input/Output System (BIOS) and processor firmware. The operating system, BIOS and firmware are used by the one or more processors 702 to control subsystems and interfaces coupled to the one or more processors 702. In some embodiments, the one or more processors 702 can include the Pentium and Itanium from Intel, the Opteron and Athlon from Advanced Micro Devices, and the ARM processor from ARM Holdings.

As illustrated in FIG. 7, the computing system 700 can include a machine-readable medium 704. In some embodiments, the machine-readable medium 704 can further include a main random-access memory (“RAM”) 706, a read only memory (“ROM”) 708, and/or a file storage subsystem 710. The RAM 706 can store instructions and data during program execution and the ROM 708 can store fixed instructions. The file storage subsystem 710 provides persistent storage for program and data files, and may include a hard disk drive, a floppy disk drive along with associated removable media, a CD-ROM drive, an optical drive, a flash memory, or removable media cartridges.

The computing system 700 can further include user interface input devices 712 and user interface output devices 714. The user interface input devices 712 can include an alphanumeric keyboard, a keypad, pointing devices such as a mouse, trackball, touchpad, stylus, or graphics tablet, a scanner, a touchscreen incorporated into the display, audio input devices such as voice recognition systems or microphones, eye-gaze recognition, brainwave pattern recognition, and other types of input devices to provide some examples. The user interface input devices 712 can be connected by wire or wirelessly to the computing system 700. Generally, the user interface input devices 712 are intended to include all possible types of devices and ways to input information into the computing system 700. The user interface input devices 712 typically allow a user to identify objects, icons, text and the like that appear on some types of user interface output devices, for example, a display subsystem. The user interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other device for creating a visible image such as a virtual reality system. The display subsystem may also provide non-visual display such as via audio output or tactile output (e.g., vibrations) devices. Generally, the user interface output devices 720 are intended to include all possible types of devices and ways to output information from the computing system 700.

The computing system 700 can further include a network interface 716 to provide an interface to outside networks, including an interface to a communication network 718, and is coupled via the communication network 718 to corresponding interface devices in other computing systems or machines. The communication network 718 may comprise many interconnected computing systems, machines and communication links. These communication links may be wired links, optical links, wireless links, or any other devices for communication of information. The communication network 718 can be any suitable computer network, for example a wide area network such as the Internet, and/or a local area network such as Ethernet. The communication network 718 can be wired and/or wireless, and the communication network can use encryption and decryption methods, such as is available with a virtual private network. The communication network uses one or more communications interfaces, which can receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. One or more communications protocols can be used, such as HTTP, TCP/IP, RTP/RTSP, IPX and/or UDP.

As illustrated in FIG. 7, the one or more processors 702, the machine-readable medium 707, the user interface input devices 712, the user interface output devices 714, and/or the network interface 716 can be communicatively coupled to one another using a bus subsystem 720. Although the bus subsystem 720 is shown schematically as a single bus, alternative embodiments of the bus subsystem may use multiple busses. For example, RAM-based main memory can communicate directly with file storage systems using Direct Memory Access (“DMA”) systems.

### CONCLUSION

The Detailed Description referred to accompanying figures to portray embodiments consistent with the disclosure. References in the disclosure to “an embodiment” indicates that the embodiment described can include a particular feature, structure, or characteristic, but every embodiment may not necessarily include the particular feature, structure, or characteristic. Moreover, such phrases are not necessarily referring to the same embodiment. Further, any feature, structure, or characteristic described in connection with an embodiment can be included, independently or in any combination, with features, structures, or characteristics of other embodiments whether or not explicitly described.

The Detailed Description is not meant to limiting. Rather, the scope of the disclosure is defined only in accordance with the following claims and their equivalents. It is to be appreciated that the Detailed Description section is intended to be used to interpret the claims.

The embodiments described within the disclosure have been provided for illustrative purposes and are not intended to be limiting. Other embodiments are possible, and modifications can be made to the embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Embodiments of the disclosure can be implemented in hardware, firmware, software application, or any combination thereof. Embodiments of the disclosure can also be implemented as instructions stored on a machine-readable medium, which can be read and executed by one or more processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software application, routines, instructions can be described herein as performing certain actions. However, it should be appreciated that such descriptions are merely for convenience and that such actions in fact result from computing systems, processors, controllers, or other devices executing the firmware, software application, routines, instructions, etc.

The Detailed Description of the embodiments fully revealed the general nature of the disclosure that others can, by applying knowledge of those skilled in relevant art(s), readily modify and/or adapt for various applications such embodiments, without undue experimentation, without departing from the spirit and scope of the disclosure. Therefore, such adaptations and modifications are intended to be within the meaning and plurality of equivalents of the embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A product distribution platform for generating a product catalog for advertising a plurality of products, the product distribution platform comprising:
a memory that stores a first computer aided design (CAD) model of a first product from among the plurality of products and a second CAD model of a second product from among the plurality of products; and
a processor configured to execute instructions stored in the memory, the instructions, when executed by the processor, configuring the processor to:
synthesize a first product image of the first product from the first product CAD model of the first product to depict the first product in a first product view in the first product image,
place the first product image and a first product description of the first product in the product catalog,
synthesize a second product image of a second product from a second product CAD model of the second product to depict the second product in a first product view in the second product image, and
place the second product image and a second product description of the second product in the product catalog.

2. The product distribution platform of claim 1, wherein the instructions, when executed by the processor, configure the processor to manipulate an orientation or an angle of the first product CAD model in a three-dimensional coordinate system to synthesize the first product image.

3. The product distribution platform of claim 2, wherein the first product CAD model of the first product depicts the first product in a second product view, and
wherein the instructions, when executed by the processor, configure the processor to manipulate an orientation or an angle of the first product CAD model from the second product view to the first product view.

4. The product distribution platform of claim 3, wherein the instructions, when executed by the processor, further configure the processor to:
import the first product CAD model into a virtual rendering studio having a plurality of virtual cameras that are associated with a plurality of product views,
rotate the orientation or the angle of the first product CAD model from the second product view to a third product view that is associated with a reference point to align the first product CAD model to the plurality of virtual cameras, and
select a virtual camera from among the plurality of virtual cameras that is associated with the first product view to depict the first product in the first product view in the first product image.

5. The product distribution platform of claim 4, wherein the instructions, when executed by the processor, further configure the processor to translate the virtual camera along a virtual line extending from the virtual camera to the first product CAD model to zoom into or zoom out of the first product CAD model.

6. The product distribution platform of claim 1, wherein the instructions, when executed by the processor, further configure the processor to:
access rendering instructions to synthesize the first product image, the rendering instructions including the first product CAD model of the first product and a render template including the first product view, and
configure a rendering tool to synthesize the first product image of the first product from the first product CAD model of the first product to depict the first product in the first product view in the first product image.

7. The product distribution platform of claim 6, wherein the rendering instructions further include a render material describing one or more materials of the first product that are to be synthesized, and
wherein the instructions, when executed by the processor, further configure the processor to project the one or more materials onto the first product CAD model to introduce surface characteristics of the one or more materials onto the first product CAD model.

8. The product distribution platform of claim 1, wherein the first product description of the first product comprises dimensions, color, finish, material, performance characteristics, pricing, or packaging of the first product.

9. A computing system for synthesizing a product image from a computer aided design (CAD) product model of a product, the computer system comprising:
a memory that stores rendering instructions for operating a rendering tool; and
a processor configured to execute a rendering tool, the rendering tool, when executed by the processor configuring the processor to:
import a computer aided design (CAD) model into a virtual rendering studio having a plurality of virtual cameras that are associated with a plurality of product views,
manipulate an orientation or an angle of the product CAD model in a three-dimensional coordinate system to align the product CAD model to the plurality of virtual cameras, and
select a virtual camera from among the plurality of virtual cameras that is associated with the product view to synthesize the product image that depicts the product in the product view.

10. The computer system of claim 9, wherein the rendering instructions include the product CAD model of the product that depicts the product in a second product view and a reference point, and
wherein the rendering tool, when executed by the processor, configures the processor to rotate the orientation or the angle of the product CAD model from the second product view to a third product view that is associated with the reference point to align the product CAD model to the plurality of virtual cameras.

11. The computer system of claim 10, wherein the rendering tool, when executed by the processor, configures the processor to:
identify at least two product views of the product CAD model within the three-dimensional space, and
identify the third product view of the product CAD model based upon the at least two product views of the product CAD model.

12. The computer system of claim 11, wherein the rendering tool, when executed by the processor, configures the processor to identify two or more of a front product view, a back-side product view, a right-side product view, a left-side product view, a top-side product view, or a bottom-side product view, that are oriented along an X-Y plane of a Cartesian coordinate system and an X-Z plane of the Cartesian coordinate system in the three-dimensional space.

13. The computer system of claim 9, wherein the rendering tool, when executed by the processor, further configures the processor to translate the virtual camera along a virtual line extending from the virtual camera to the product CAD model to zoom into or zoom out of the product CAD model.

14. The computer system of claim 9, wherein the rendering instructions include the product CAD model of the product, a render template including the product view, a render material describing one or more materials of the product that are to be synthesized, and
wherein the rendering tool, when executed by the processor, further configures the processor to project the one or more materials onto the product CAD model to introduce surface characteristics of the one or more materials onto the product CAD model.

15. A method for synthesizing a product image from a computer aided design (CAD) product model of a product, the method comprising:
importing, by a computer system, a computer aided design (CAD) model into a virtual rendering studio having a plurality of virtual cameras that are associated with a plurality of product views,
manipulating, by the computer system, an orientation or an angle of the product CAD model in a three-dimensional coordinate system to align the product CAD model to the plurality of virtual cameras, and
selecting, by the computer system, a virtual camera from among the plurality of virtual cameras that is associated with the product view to synthesize the product image that depicts the product in the product view.

16. The method of claim 15, wherein the rendering instructions include the product CAD model of the product that depicts the product in a second product view and a reference point, and
wherein the manipulating comprises rotating the orientation or the angle of the product CAD model from the second product view to a third product view that is associated with the reference point to align the product CAD model to the plurality of virtual cameras.

17. The method of claim 16, wherein the manipulating comprises:
identifying at least two product views of the product CAD model within the three-dimensional space; and
identifying the third product view of the product CAD model based upon the at least two product views of the product CAD model.

18. The method of claim 17, wherein the identifying at least two product view comprises identifying two or more of a front product view, a back-side product view, a right-side product view, a left-side product view, a top-side product view, or a bottom-side product view, that are oriented along an X-Y plane of a Cartesian coordinate system and an X-Z plane of the Cartesian coordinate system in the three-dimensional space.

19. The method of claim 15, further comprising translating the virtual camera along a virtual line extending from the virtual camera to the product CAD model to zoom into or zoom out of the product CAD model.

20. The method of claim 15, wherein the rendering instructions include the product CAD model of the product, a render template including the product view, a render material describing one or more materials of the product that are to be synthesized, and
further comprising projecting the one or more materials onto the product CAD model to introduce surface characteristics of the one or more materials onto the product CAD model.
